(19) United States
(12) Patent Application Publication
(10) Pub. No.: US 2025/0382988 A1
(43) Pub. Date: Dec. 18, 2025

(54) AUTOMOTIVE ENGINE STARTER BRACKET

(71) Applicants: Mark S. Sassman, Carmel, IN (US); Michael J. Sassman, Carmel, IN (US)

(72) Inventors: Mark S. Sassman, Carmel, IN (US); Michael J. Sassman, Carmel, IN (US)

(21) Appl. No.: 18/742,834

(22) Filed: Jun. 13, 2024

(51) Int. Cl. F16B 39/38; F16B 43/00

(52) U.S. Cl. CPC F16B 39/38; F16B 43/00; F16B 2200/506

(57) ABSTRACT

A bracket is provided to secure a starter to an engine block and a transmission. The bracket includes a transmission bracket portion, a spacer, and a starter bracket portion. The transmission bracket portion includes a body adapted to be coupled to the transmission. The spacer extends from a first end to a second end. The first end of the spacer is adapted to be coupled to the body of the transmission bracket portion. The starter bracket portion includes a body adapted to be coupled to the starter. The starter bracket portion is adapted to be coupled to the second end of the spacer.

### TECHNICAL FIELD

This disclosure relates to accessories for use in automotive engines and, in particular, brackets usable to stabilize a starter within an engine.

### BACKGROUND

The statements in this section merely provide background information related to the present disclosure and may not constitute prior art.

Starters are commonly mounted to engine blocks within automobiles to provide an initial start to the engine. Typically, the starter is mounted on a rear panel or surface of the engine block using two bolt holes. On LS-based and LT-based engine blocks, one of the bolt holes is arranged on an ear that extends outward from the engine block. During operation of the engine, starter torque, vibration, and other stresses can cause this ear to crack or break away from the rest of the engine block, causing the starter to become loose or unstable. Therefore, a device to reduce mechanical stress on the ear and better stabilize the starter is desirable. Furthermore, when the ear of the engine block has been broken, a device to reliably couple the starter to the engine block is desirable.

### SUMMARY

Further areas of applicability will become apparent from the description provided herein. It should be understood that the description and specific examples are intended for purposes of illustration only and are not intended to limit the scope of the present disclosure.

In one embodiment a bracket is provided adapted to secure a first component to a second component within an engine. The bracket includes a first portion, a spacer, and a second portion. The first portion includes a body defining at least two bolt holes. Each of the bolt holes are adapted to be aligned with matching bolt holes on the first component. Bolts are insertable through the two bolt holes of the first portion along a first direction. The spacer extends from a first end to a second end. The spacer is coupled to the body of the first portion at the first end of the spacer. The spacer extends outward from the body of the first portion in the first direction. The second portion includes a body coupled to the second end of the spacer. The body of the second portion defines a threaded hole adapted to be aligned with a matching threaded hole of the second component. A threaded rod is insertable through the threaded hole of the second portion along a second direction.

In another embodiment, a bracket is provided to secure a starter to an engine block and a transmission. The bracket includes a transmission bracket portion, a spacer, and a starter bracket portion. The transmission bracket portion includes a body adapted to be coupled to the transmission. The spacer extends from a first end to a second end. The first end of the spacer is adapted to be coupled to the body of the transmission bracket portion. The starter bracket portion includes a body adapted to be coupled to the starter. The starter bracket portion is adapted to be coupled to the second end of the spacer.

In yet another embodiment, a method of securing a starter to a transmission within an engine. The method includes the steps of coupling a transmission bracket portion to the transmission, coupling a first end of a spacer to the transmission bracket portion, coupling a starter bracket portion to a second end of the spacer, and coupling the starter bracket portion to the starter.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a partial perspective view of a first example of an engine block;

FIG. 2 illustrates a partial perspective view of a first example of an engine including an engine block, a starter, a transmission, and a bracket;

FIG. 3 illustrates an exploded perspective view of a first example of a bracket including a transmission bracket portion, a spacer, and a starter bracket portion;

FIG. 4 illustrates a perspective view of a second example of a transmission bracket portion;

FIG. 5 illustrates a partial perspective view of a second example of an engine, including an engine block, a transmission, and a transmission bracket portion;

FIG. 6 illustrates a side cross-sectional view of a second example of a spacer;

FIG. 7 illustrates a perspective view of a second example of a starter bracket portion and of a fastener;

FIG. 8 illustrates a partial perspective view of a second example of an engine block in a damaged condition including an alignment tool.

FIG. 9 illustrates a perspective view of a second example of an alignment tool; and

FIG. 10 illustrates a flow diagram of operations to secure a starter to a transmission within an engine.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In one embodiment a bracket is provided adapted to secure a first component to a second component within an engine. The bracket includes a first portion, a spacer, and a second portion. The first portion includes a body defining at least two bolt holes. Each of the bolt holes are adapted to be aligned with matching bolt holes on the first component. Bolts are insertable through the two bolt holes of the first portion along a first direction. The spacer extends from a first end to a second end. The spacer is coupled to the body of the first portion at the first end of the spacer. The spacer extends outward from the body of the first portion in the first direction. The second portion includes a body coupled to the second end of the spacer. The body of the second portion defines a threaded hole adapted to be aligned with a matching threaded hole of the second component. A threaded rod is insertable through the threaded hole of the second portion along a second direction.

One technical advantage of the systems and methods described below may be that the bracket may diminish stress from torque caused by starter operation, as well as vibrations of the starter, thereby reducing mechanical stress on vulnerable portions of the engine block. Another technical advantage of the systems and methods described below may be that the bracket may be used to securely couple the starter to the engine block even when portions of the engine block have been cracked or broken off with no threads remaining.

Yet another technical advantage of the systems and methods described below may be that the bracket may be arranged to compactly fit within the constrained space of a car engine cavity. For example, the bracket may securely couple the starter to the engine block while not interfering with the placement of close fit exhaust headers or other components. Such compact arrangement may ensure that the bracket may be installed within further time consuming modifications to other engine components.

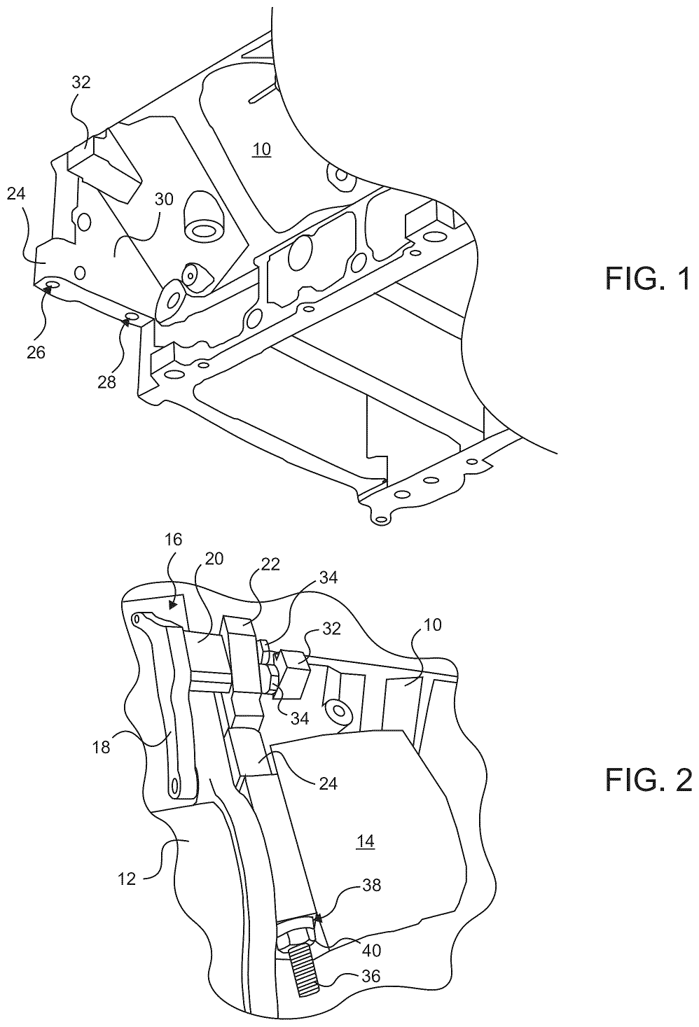

FIG. 1 illustrates a perspective view of a portion of an engine block 10. The engine block 10 may be any portion of an engine which contains the cylinders for driving the engine. Examples of the engine block 10 may include a V6 engine block or a V8 engine block, or any other reciprocating engine. In some embodiments, the engine block 10 may be from a standard family of engine blocks 10, such as the LS based small engine blocks or the LT based small engine blocks. The engine block 10 may be made from any material capable of capable of supporting combustion, such as aluminum or steel. The engine block 10 may be formed as an integral component in a single casting.

Several components of the engine may be coupled to the engine block 10, such as the transmission (12 in FIG. 2) or the starter (14 in FIG. 2). For example, the engine block 10 may include a rear panel 30 designed to be coupled to the transmission 12. The engine block 10 may also include one or more casting artifacts 32 which may be integral to the engine block. The casting artifacts 32 may not be coupled to any portion of the engine and may constrain placement of other components in and around the engine block. The casting artifacts 32 may be removeable by grinding or cutting, however, this requires a great deal of effort and risks damaging the structure of the engine block 10 as a whole.

Additionally, the rear panel 30 may also include openings (26, 28) to allow the starter 14 to be coupled to the engine block 10. A first opening 28 for the starter 14 may be located close to the center of the engine block 10. A second opening 26 for the starter 14 may be located further from the center of the engine block 10. In some embodiments, such as in the LS based small engine blocks, the second opening 26 may be arranged on an ear 24 which protrudes from the main body of the engine block 10. Examples of the ear 24 may include a protrusion, a flange, or a projection. The ear 24 may be integral to the rest of the engine block 10, but may also be more vulnerable to mechanical stress than other portions of the engine block 10.

FIG. 2 illustrates a partial perspective view of an example of the engine including the engine block 10, the transmission 12, the starter 14, and a bracket 16. The transmission 12 may be any component of the engine which may be coupled to the engine block 10 and which converts kinetic energy within the engine into kinetic energy for an output. Examples of the transmission may include a multi-ratio transmission for an automobile or a fixed ration transmission for a pump. The transmission 12 may include a casing which is coupled to the rear panel 30 of the engine block 10. The starter 14 may be any component of the engine which may be coupled to the engine block 10 and which may be used to initiate operation of the engine. Examples of the starter 14 may include an electric starter or a pneumatic starter. The starter 14 may be coupled to the rear panel 30 of the engine block 10 using at least two openings (26, 28) to sufficiently secure the starter 14 to the engine block 10 and minimize vibrations of the starter 14 and minimize torque from operation of the starter 14.

The bracket 16 may be any component of the engine which may be coupled to the transmission 12 and the starter 14 to stabilize the starter 14 and better secure the starter 14 within the engine. In some embodiments the bracket 16 may also be coupled to the ear 24 of the engine block 10, as illustrated in FIG. 2. The bracket 16 may include a transmission bracket portion 18, a spacer 20, and a starter bracket portion 22.

The transmission bracket portion 18 may be any portion of the bracket 16 which is adapted to be coupled to the transmission 12. The starter bracket portion 22 may be any portion of the bracket 16 which is adapted to be coupled to the starter 14. The spacer 20 may be any portion of the bracket 16 which is coupled to and extends between the transmission bracket portion 18 and the starter bracket portion 22.

In some embodiments, the transmission bracket portion 18, the spacer 20, and the starter bracket portion 22 may be an integral part. In other embodiments, each of the transmission bracket portion 18, the spacer 20, and the starter bracket portion 22 may be separable and securable together by one or more fasteners 34 extending between the transmission bracket portion 18, the spacer 20, and starter bracket portion 22. In some embodiments, the width of the bracket 16 and the fasteners may be constrained by other components within the engine, such as the casting artifact 32 of the engine block 10 shown in FIG. 2.

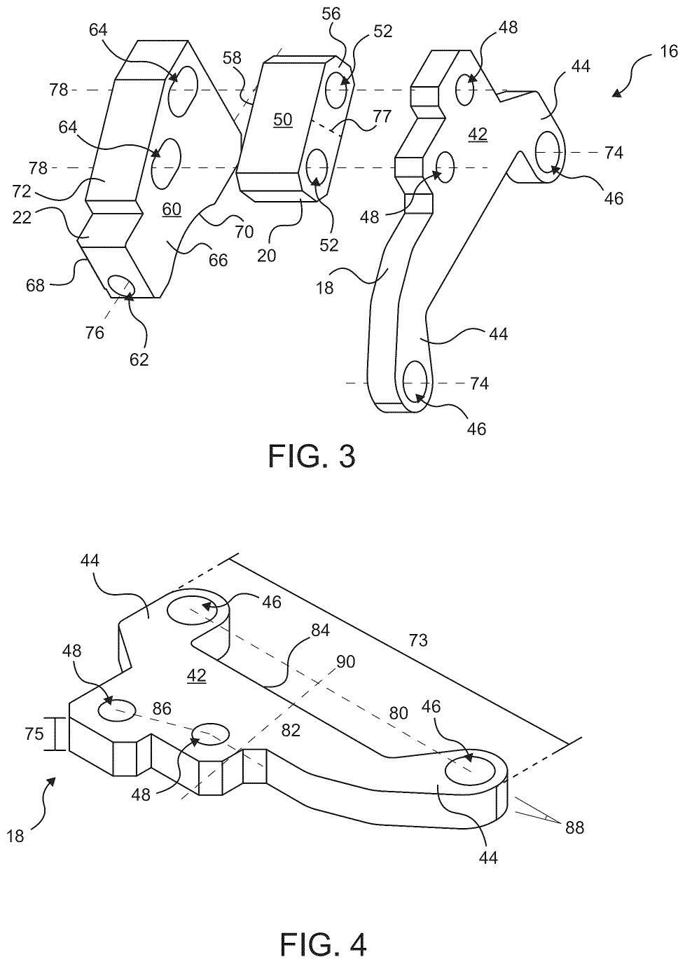

The starter 14 may be secured to the bracket 16 and to the ear 24 of the engine block 10 by a threaded rod 36. The threaded rod 36 may be any component which extends from a threaded opening 38 within the starter 14 to a threaded opening (62 in FIG. 3) within the starter bracket portion 22. Examples of the threaded rod 36 may include an elongated body, a threaded bolt, or another fastening device. In some embodiments, as illustrated in FIG. 2, the threaded rod 36 may also extend through the opening 26 of the ear 24 of the engine block 10, arranged between the starter 14 and the starter bracket portion 22. The threaded rod 36 may be secured within the threaded opening 38 of the starter 14 by a nut 40 which rests against a surface of the starter 14.

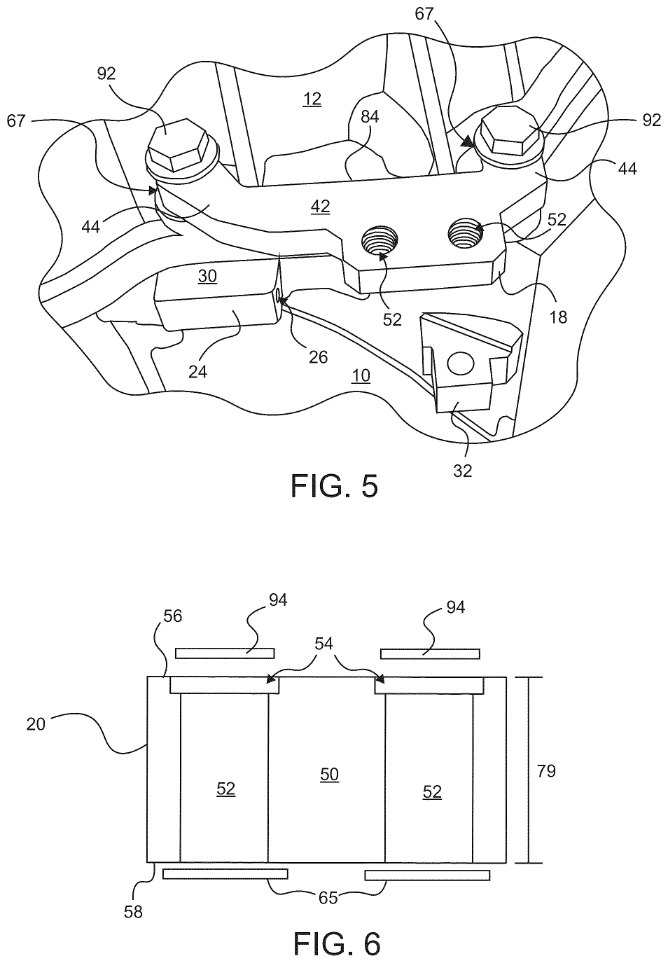

FIG. 3 illustrates a perspective view of an embodiment of the bracket 16 including the transmission bracket portion 18, the spacer 20, and the starter bracket portion 22. The transmission bracket portion 18 may include a body 42 with two legs 44. The body 42 may be any part of the transmission bracket portion 18 which forms the shape of the transmission bracket portion 18. The body 42 of the transmission bracket portion 18 may be a single integral part and may be made of any material suitable for coupling the bracket 16 to the transmission 12 such as aluminum, steel, ceramic, or rubber. The legs 44 may be any portion of the body 42 which extends outwardly from a center of the body 42 and which is adapted to be positioned over a portion of the transmission 12. Each of the legs 42 may define a bolt hole 46 adapted to be aligned with matching bolt holes on the transmission 12. The bolt holes 46 of the transmission bracket portion 18 may be threaded or unthreaded. The bolt holes 46 may be arranged such that bolts (92 in FIG. 5) may be inserted into the bolt holes 46 along a bolt axis 74 in a first direction. The body 42 of the transmission bracket portion 18 may also define one or more fastener openings 48 to allow the fastener 34 to be coupled to the body 42 of the transmission bracket portion 18. The bolts 92 used to secure the transmission bracket portion 18 to the transmission 12 may be longer than standard bolts used to couple the transmission 12 to the engine block 10 due to the thickness of the transmission bracket portion 18.

The spacer 20 may include a body 50. The body 50 of the spacer 20 may be any part of the spacer 20 which forms the shape of the spacer 20. The body 50 of the spacer 20 may be a single integral part and may be made of any material suitable for coupling the spacer 20 to the transmission bracket portion 18 and the starter bracket portion 22, such as aluminum, steel, ceramic, or rubber. The body 50 of the spacer 20 may also define one or more fastener openings 52 to allow the fastener 34 to pass through the spacer 20. The fastener openings 52 of the spacer 20 may be threaded or unthreaded.

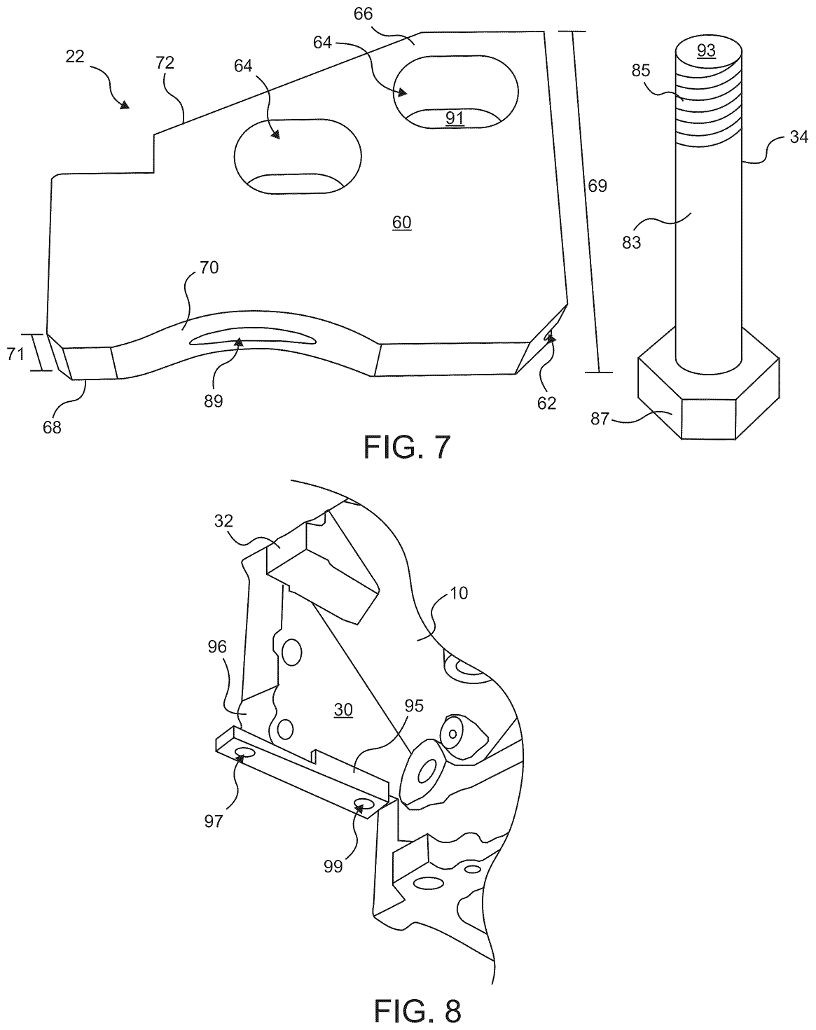

The spacer 20 may extend from a first end 56 to a second end 58. The first end 56 may include a surface adapted to engage with the body 42 of the transmission bracket portion 18. Similarly, the second end 58 may include a surface adapted to engage with the body of the transmission bracket portion 20. As illustrated in FIG. 3, the spacer 20 may have a length (79 in FIG. 6) which is greater than a length (75 in FIG. 4) of the transmission bracket portion 18 and a length (71 in FIG. 7) of the starter bracket portion 22. Furthermore, the spacer 20 may have a width which is less than a width (73 in FIG. 4) of the transmission bracket portion 18 and a width (69 in FIG. 7) of the starter bracket portion 22. The greater length and smaller width of the spacer 20 may allow the bracket 16 to be arranged around various portions of the engine block 10 and transmission 12 which may project outward and make coupling the starter 14 to the transmission 12 difficult.

The starter bracket portion 22 may include a body 60. The body 60 may be any part of the starter bracket portion 22 which forms the shape of the starter bracket portion 22. The body 60 of the starter bracket portion 22 may be a single integral part and may be made of any material suitable for coupling the bracket 16 to the starter 14 such as aluminum, steel, ceramic, or rubber. The body 60 of the starter bracket portion 22 may define a threaded hole 62 adapted to be aligned with the matching threaded hole 38 on the starter 14. The threaded hole 62 of the starter bracket portion 22 may be threaded. The threaded hole 62 of the starter bracket portion 22 may be arranged such that the threaded rod 36 may be inserted into the threaded hole 62 along a threaded rod axis 76 arranged in second direction. The second direction may be angularly offset from the first direction and may be orthogonal to the first direction.

The body 60 of the starter bracket portion 22 may include an interior surface 66 adapted to engage with the second end 58 of the spacer 20. The body 60 may also define an exterior surface 68 opposed to the interior surface 66, a curved surface 70 shaped to avoid portions of the engine block 10 or transmission 12, and a slanted surface 72 shaped to avoid other components within the engine. The body 60 of the starter bracket portion 22 may also define one or more fastener openings 64 to allow the fastener 34 to be coupled to the body 60 of the starter bracket portion 22. The fastener 34 may be inserted from the exterior surface 68, through the fastener opening 64 of the starter bracket portion 22, through the fastener opening 52 of the spacer 20 and through the fastener opening 48 of the transmission bracket portion 18 to secure the bracket 16. The fastener 34 is arranged within the bracket along a fastener axis 78, which may be parallel to the bolt axis 74, also arranged along the first direction.

FIG. 4 illustrates a perspective view of the transmission bracket portion 18. In some embodiments, the bolt holes 46 of the transmission bracket portion 18 may be arranged along a bolt hole axis 80, arranged within a plane defined by the body 42 of the transmission bracket portion 18 and angularly offset from or orthogonal to the bolt axis 74. At least one of the fastener openings 82 may be separated by an offset 82 in a third direction from the bolt holes 46 and the bolt hole axis 80. The offset 82 may be arranged in a third direction which is orthogonal to both the first direction and the second direction. The offset 82 allows the bracket 16 to have a C-shape with respect to the engine block 10 and the transmission 12, thereby avoiding portions of the engine block 10 and the transmission 12 which may protrude under the transmission bracket portion 18.

In some embodiments, such as when the transmission bracket portion 18 includes more than one fastener opening 48, the fastener openings 48 may be arranged along a fastener opening axis 86. The fastener opening axis 86 may form an angle 88 with the bolt hole axis 80 of between 10 to 45 degrees, typically no more than 30 degrees. The angular offset of the fastener hole axis 86 may allow the spacer 20 to avoid portions of the engine block 10 and the transmission 12 and also avoid other components of the engine.

FIG. 5 illustrates a perspective view of an example of the engine including the engine block 10, the transmission 12, and the transmission bracket portion 18 of the bracket 16. As illustrated in FIG. 5, the legs 44 of the transmission bracket portion 18 may be positioned over bolt holes 67 of the transmission 12 such that the bolt holes 46 of the transmission bracket portion 18 and the bolt holes 67 of the transmission 12 are aligned. Typically, the bolt holes 67 of the transmission 12 may be used to couple the transmission 12 to the rear panel 30 of the engine block 10. Once aligned the bolts 92 may then be inserted to couple the transmission bracket portion 18 to the transmission 12 and couple the transmission 12 to the engine block 10.

The body 42 of the transmission bracket portion 18 may also define a shaped surface 84 between the legs 44. The shaped surface 84 may be arranged to avoid portions of the transmission 12 which protrude outward into a region between the legs 44 of the transmission bracket portion 18.

FIG. 6. Illustrates a side cross-sectional view of an example of the spacer 20 including two fastener openings 52. The body 50 of the spacer 20 may additionally define a recess 54 arranged at the first end 56 of the spacer 20 within each fastener opening 52. The recess 54 may be adapted to receive an O-ring 94 which is adapted to rest between the spacer 20 and the transmission bracket portion 18. The O-ring 94 may be made of any material which is more compressible than the material of the spacer 20, such as rubber. The O-ring 94 may be helpful to hold the spacer 20, the transmission bracket portion 18, and a fastener (34 in FIG. 7) in place while an operator is securing the fastener 34.

FIG. 7 illustrates a perspective view of an example of the starter bracket portion 22 and the fastener 34. The fastener 34 may be any component which may extend through the starter bracket portion 22, the spacer 20, and the transmission bracket portion 18 to secure the bracket 16. The fastener 34 may included a head 87, a threaded portion 85, and an unthreaded portion 83. The head 87 may be any portion of the fastener 34 which is adapted to engage with the exterior surface 68 of the starter bracket portion 22. The head 87 may be wider than the threaded portion 85 and unthreaded portion 83 of the fastener 34 to allow fastener 34 to pass partially but not entirely though the fastener openings 64 of the starter bracket portion 22. The threaded portion 85 may be any part of the fastener 34 which is adapted to engage with the threaded fastener openings 48 of the transmission bracket portion 18 to secure the bracket 16 together as a whole component. The unthreaded portion 83 of the fastener 34 may be any portion of the fastener 34 which is adapted to pass through the fastener openings 52, 64 of the spacer 20 and the starter bracket portion 22.

In some embodiments the positioning of the fastener 34 may be reversed. For example, in such an embodiment, the head 87 of the fastener 34 may engage with the head of the transmission bracket portion 18. The unthreaded portion 83 may pass through the fastener openings 48, 52 of the transmission bracket portion 18 and the spacer 20. The threaded portion 85 may engage with the threaded fastener opening 64 of the starter bracket portion 22 to secure the bracket 16 together as a whole component.

The fastener openings 64 of the starter bracket portion 22 may be larger than the fastener openings 48, 52 of the spacer 20 and the transmission bracket portion 18 to allow an area whereby the position of the starter bracket portion 22 may be adjusted as the fastener 34 is being secured. This area for adjustment may allow better alignment between the threaded hole 62 of the starter bracket portion 22 with the threaded hole 26 of the ear 24 and the threaded hole 38 of the starter 14. For example, a cross-sectional area 91 of the fastener opening 64 of the starter bracket portion 22 may be at least 10% larger than a cross-sectional area 93 of the unthreaded portion 83 of the fastener 34. To allow the head 87 of the fastener 34 to engage with the starter bracket portion 22, the width of the fastener opening 64 of the starter bracket portion 22 may not be larger than the head 87 of the fastener 34.

In some embodiments, the threaded rod 36 may be arranged within the threaded hole 62 of the starter bracket portion 22 such that it does not extend into the curved surface 70. However, in some embodiments, such as where protruding portions of the engine block 10 have been ground down, the threaded rod 36 may extend into or through the curved surface 70 to better secure the starter 14 to the bracket 16. In such an embodiment, the curved surface 70 may include a partially threaded opening 89 to accommodate this possible use of the threaded rod 36.

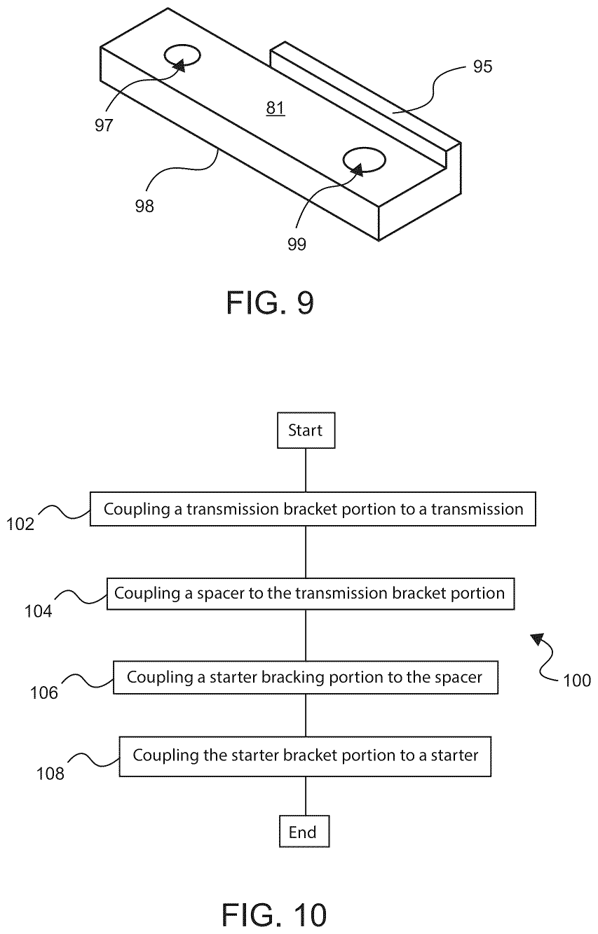

FIG. 8 illustrates a partial perspective view of an example of the engine block 10 and an alignment tool 98. FIG. 9 illustrates a perspective view of an example of the alignment tool 98. In some embodiments, the ear 24 of the engine block 10 may be broken off, leaving only an irregular or ground down surface 96 on the engine block 10. In such embodiments, the alignment tool 98 may be used to properly align the starter bracket portion 22 for the starter 14 and the threaded rod 36. The alignment tool 98 may include an inner opening 99 adapted to be aligned with the first opening 28 of the engine block 10 such that the alignment tool 98 may be coupled with the engine block 10. The alignment tool 98 may also include an outer opening 97 which, when the alignment tool 98 is coupled to the engine block 10, is positioned where the second opening 26 at the ear 24 of the engine block 10 would have been. The alignment tool 98 may also include an engagement surface 81 adapted to engage with the contour of the rear panel 30 of the engine block 10 and a lip 95 adapted to extend over the rear panel 30 of the engine block 10.

The engagement surface 81, inner opening 99, and lip 95 may fix the alignment tool 98 within three dimensions to accurately align the threaded rod 36 with the starter bracket portion 22 and the starter 14. Once the starter bracket portion 22 has been secured in place, the alignment tool 98 may be removed from the engine block 10 to allow the starter 14 to be coupled to the engine block 10.

Furthermore, although specific components are described above, methods, systems, and articles of manufacture described herein may include additional, fewer, or different components. For example, the bracket 16 may include only one fastener 34 or may include three fasteners 34.

FIG. 10 illustrates a flow diagram of operations to secure the starter 14 to the transmission 12 within the engine (100). The operations may include fewer, additional, or different operations than illustrated in FIG. 10. Alternatively or in addition, the operations may be performed in a different order than illustrated.

Initially, the operations (100) may include coupling the transmission bracket portion 18 to the transmission 12 (102). Once the transmission bracket portion 18 has been secured, the first end 56 of the spacer 20 may be coupled to the transmission bracket portion 18 (104). Furthermore, the starter bracket portion 22 may be coupled to the second end 58 of the spacer 20 (106). These steps 104, 106, may be performed simultaneously.

Once the starter bracket portion 22 has been positioned, the alignment between the threaded opening 38 of the starter 14 and the threaded opening 62 of the starter bracket portion 22 may be assessed. This assessment may be performed even without the starter 14, using the second opening 26 on the ear 24 of the engine block 10 or the alignment tool 98 as an indicator of such an alignment. If the alignment is incorrect, shims (65 in FIG. 6) may be added between the interior surface 66 of the starter bracket portion 22 and the second end 58 of the spacer 20 to adjust the alignment. Once the alignment is satisfactory, the starter bracket portion 22 may be coupled to the starter 14 (108) by inserting the threaded rod 36 through the threaded opening 38 of the starter 14, through the second opening 26 on the ear 24 of the engine block 10 (if present), and through the threaded opening 62 of the starter bracket portion 22.

In addition to the advantages that have been described, it is also possible that there are still other advantages that are not currently recognized but which may become apparent at a later time. While various embodiments have been described, it will be apparent to those of ordinary skill in the art that many more embodiments and implementations are possible. Accordingly, the embodiments described herein are examples, not the only possible embodiments and implementations.

What is claimed is:

1. A bracket adapted to secure a first component to a second component within an engine, comprising
a first portion comprising a body defining at least two bolt holes, wherein each of the at least two bolt holes are adapted to be aligned with matching bolt holes of the first component such that bolts may be inserted through the at least two bolt holes of the first portion along a first direction;
a spacer extends from a first end to a second end, wherein the spacer is coupled to the body of the first portion at the first end of the spacer and the spacer extends outward from the body of the first portion in the first direction; and
a second portion comprising a body coupled to the second end of the spacer, wherein the body of the second portion defines a threaded hole adapted to be aligned with a matching threaded hole of the second component such that a threaded rod may be inserted through the threaded hole of the second portion along a second direction angularly offset from the first direction;

2. The bracket of claim 1, further comprising a fastener, wherein each of the first portion, the spacer, and the second portion are separable and the fastener is adapted to couple each of the first portion, the spacer, and the second portion together.

3. The bracket of claim 1, wherein the body of the first portion defines a threaded opening adapted to receive a threaded portion of the fastener.

4. The bracket of claim 2, wherein:
the body of the second portion defines an unthreaded opening adapted to receive the fastener;
the body of the second portion comprises a receiving surface opposed on the body of the second portion from the second end of the spacer; and
the fastener comprises a head adapted to rest against the receiving surface of the second portion.

5. The bracket of claim 2, wherein the second portion defines an opening adapted to receive the fastener, wherein the opening of the second portion is at least 10% larger than a cross-sectional area of the fastener.

6. The backet of claim 1, further comprising a shim positioned between the second end of the spacer and the second portion.

7. The bracket of claim 1, further comprising an o-ring, wherein the first end of the spacer defines a recess adapted to receive the o-ring.

8. The bracket of claim 1, wherein the first direction is angularly offset from the second direction.

9. The bracket of claim 8, wherein
the body of the transmission bracket portion defines a fastener opening separated from the bolt holes by an offset in a third direction from an axis extending between the at least two bolt holes;
the third direction is angularly offset from both the first direction and the second direction; and
the first end of the spacer is coupled to the body of the first portion at the fastener opening.

10. A bracket adapted to secure a starter to an engine block and a transmission, comprising:
a transmission bracket portion comprising a body adapted to be coupled to the transmission;
a spacer extends from a first end and a second end, wherein the first end of the spacer is adapted to be coupled to the body of the transmission bracket portion such that the spacer extends outward from the body of the transmission bracket portion; and
a starter bracket portion comprising a body adapted to be coupled to the starter, wherein the starter bracket portion is adapted to be coupled to the second end of the spacer.

11. The bracket of claim 10, wherein the body of the transmission bracket portion defines at least two bolt holes, wherein each of the at least two bolt holes are adapted to be aligned with a matching transmission bolt hole such that bolts may be inserted through the at least two bolt holes.

12. The bracket of claim 10, wherein the body of the starter bracket portion defines a threaded hole adapted to be aligned with a matching starter threaded hole such that a threaded rod may be inserted through the threaded hole of the starter bracket portion and the starter threaded hole.

13. The bracket of claim 12, wherein the threaded hole of the second portion is further adapted to be aligned with a matching threaded hole define by a portion of an engine block positioned between the starter and the starter bracket portion.

14. The bracket of claim 12, further comprising an adaptor comprising a body, wherein the body defines an opening and the adaptor is adapted to be removably coupled to an engine block such that the opening of the adaptor may be used to align the threaded hole of the starter bracket portion with the threaded hole of the starter.

15. A method of securing a starter to a transmission within an engine, comprising:
coupling a transmission bracket portion to the transmission;
coupling a first end of a spacer to the transmission bracket portion;
coupling a starter bracket portion to a second end of the spacer; and
coupling the starter bracket portion to the starter.

16. The method of claim 15, wherein coupling the starter bracket portion to the starter comprises inserting a threaded rod at least partially through each of the starter and the starter bracket portion.

17. The method of claim 16, wherein coupling the starter bracket portion to the starter further comprises inserting the threaded rod through a portion of an engine block positioned between the starter bracket portion and the starter.

18. The method of claim 16, further comprising:
after coupling the starter bracket portion to the second end of the spacer, assessing alignment between an opening in the starter and an opening in the starter bracket portion; and
adjusting a number of shims positioned between the second end of the spacer and the starter bracket portion to align the opening in the starter and the opening in the starter bracket.

19. The method of claim 16 further comprising, before coupling the starter bracket portion to the second end of the spacer, coupling an alignment tool to an engine block wherein the alignment tool comprises an opening arranged to receive the threaded rod when aligned with an opening in the starter bracket portion.

20. The method of claim 19, further comprising removing the alignment tool from the engine block after coupling the starter bracket portion to the second end of the spacer.
